(19) United States
(12) Patent Application Publication
(10) Pub. No.: US 2018/0311873 A1
(43) Pub. Date: Nov. 1, 2018

(54) HYBRID PANEL AND MOLD THEREFOR

(71) Applicant: Vuteq Canada Inc., Woodstock (CA)

(72) Inventor: Anthony Sekli, Woodstock (CA)

(73) Assignee: Vuteq Canada Inc., Woodstock (CA)

(21) Appl. No.: 15/964,583

(22) Filed: Apr. 27, 2018

Related U.S. Application Data
(60) Provisional application No. 62/491,032, filed on Apr. 27, 2017.

(51) Int. Cl. B29C 45/14; B29C 45/26

(52) U.S. Cl. CPC B29C 45/14344; B29K 2667/00; B29C 45/26

(57) ABSTRACT

An injection mold for producing a hybrid panel having a decorative material bordered by a thermoplastic resin has laterally outwardly off-set stand-offs on opposed mold halves, which create pinch points that permit bordering the decorative material with the thermoplastic material only at the edges of the decorative material without permitting molten resin to bleed through to the visible class A surface of the decorative material. The resulting panel has an indent separating the front surface of the decorative inner portion from the thermoplastic resin border along an intersection between the decorative material and the thermoplastic resin border, which provides a clean, visually appealing transition between the class A surface of the decorative material and the thermoplastic resin border.

### CROSS-REFERENCE TO RELATED APPLICATIONS

This application claims the benefit of U.S. Provisional Patent application U.S. Ser. No. 62/491,032 filed Apr. 27, 2017, the entire contents of which is herein incorporated by reference.

### FIELD

This application relates to hybrid panels of a decorative material bordered by a thermoplastic resin and processes and molds for producing such panels.

### BACKGROUND

Trim panels, for example for vehicle interiors, have been produced in a number of ways. In one method, an injection molded thermoplastic resin is placed in a secondary press operation to laminate a carpet material to the molded thermoplastic part using an adhesive material. Trim panels have also been produced utilizing an injection molded thermoplastic part and a compression molded carpet material assembled together with a heat stake or sonic weld operation. Fasteners are also a typical way of fastening carpet material to a molded thermoplastic part. Trim panels may be mounted to the interior of a vehicle for a visually appealing finish by means of fasteners.

The above described methods of producing trim panels are generally suitable. However, there is an increased requirement to produce trim panels at reduced cost, which are lighter (reduced mass) and more visually appealing.

There remains a need for improved trim panels and processes for producing trim panels.

### SUMMARY

In one aspect, there is provided an injection mold for producing a hybrid panel having a decorative material bordered by a thermoplastic resin, the injection mold comprising: a first mold part comprising a first face having a perimeter defining a laterally outward-most edge of the first face, a first cavity in the first face having a first inner surface, a first stand-off having a first height extending from and immovable with respect to the first inner surface, the first cavity divided into an inner mold section and an outer mold section by the first stand-off, the inner mold section configured to contain a first portion of the decorative material that remains uncovered by the thermoplastic resin, the outer mold section configured to contain a second portion of the decorative material that is to be covered on one side by the thermoplastic resin when the thermoplastic resin is injected into the outer mold section to thereby form an interface between the decorative material and the thermoplastic resin; and, a second mold part comprising a second face having a perimeter defining a laterally outward-most edge of the second face, the second face configured to mate with the first face to close the mold, a core in the second face comprising a second cavity shallower than the first cavity and having a second inner surface, the second cavity configured to contain the second portion of the decorative material over the outer mold section of the first cavity, a second stand-off having a second height extending from and immovable with respect to the second inner surface, the second height smaller than the first height, the second stand-off off-set laterally outwardly from the first stand-off and projecting into the outer mold section when the mold is closed.

In another aspect, there is provided a hybrid panel comprising a decorative material having a class A front surface and a class B back surface, the decorative material bordered by a border of a thermoplastic resin, the decorative material comprising an inner decorative portion not covered by thermoplastic resin and an outer thinner portion covered on the front surface by the thermoplastic resin, the front surface of the decorative inner section separated from the thermoplastic resin by an indent along an intersection between the decorative material and the thermoplastic resin.

In another aspect, there is provided a process for producing a hybrid panel having a decorative material bordered by a thermoplastic resin, the process comprising: placing a decorative material in an injection mold of the present invention; injecting molten thermoplastic resin into the outer mold section of the first mold part; allowing the thermoplastic resin to cool and solidify; and, separating the first and second mold parts and removing the hybrid panel formed therein from the mold.

In one embodiment, the second cavity has smaller perimetrical dimensions than the first cavity. When the second cavity has smaller perimetrical dimensions than the first cavity, no part of the second cavity extends laterally outwardly beyond edges of the first cavity.

Therefore, the first and second faces of the mold can form a seal when the mold is closed to prevent injected thermoplastic resin from flowing around and/or over an outer perimetrical edge of the second portion of the decorative material in the mold. As a result, the thermoplastic resin border may interface with a front side of the second portion of the decorative material while an outer perimetrical edge face of the decorative material remains uncovered by the thermoplastic resin border. In addition, the thermoplastic resin border cannot therefore wrap around the outer perimetrical edge of the second portion of the decorative material, which contributes to a much cleaner overall appearance of the panel. In one embodiment, the thermoplastic resin border can extend well beyond the outer perimetrical edge face of the decorative material, further concealing the outer perimetrical edge face, thereby further contributing to the clean appearance of the panel. In one embodiment, the first and second mold parts are configured to compress the second portion of the decorative material, which results in the second portion of the decorative material being thinner than the first portion of the decorative material when the decorative material is in the mold. The first and second mold parts may be configured to leave the first portion of the decorative material uncompressed when the decorative material is in the mold.

In one embodiment, the second mold part may further comprise at least one stake-forming feature, preferably a plurality of stake-forming features. The stake-forming feature may be situated over the outer mold section of the first cavity when the mold is closed. The stake-forming feature may be situated laterally inwardly of a perimeter of the second cavity. The stake-forming feature may be configured to receive thermoplastic resin to form a molded thermoplastic stake through the second portion of the decorative material to help bond the decorative material to the thermoplastic resin at the interface between the injected thermoplastic resin and a front side of the second portion of the decorative material.

The stake-forming feature may comprise a deeper portion of the second cavity. The deeper portion may have a protrusion extending therein from the second inner surface. The deeper portion may be situated over a flow-through aperture in the second portion of the decorative material so that the protrusion extends into the aperture leaving a gap between the protrusion and an inner edge of the aperture for molten thermoplastic resin injected into the mold to flow through the gap. The aperture may have a smaller cross-sectional area than a cross-sectional area of the deepest portion of the deeper portion to permit molten thermoplastic resin flowing through the decorative material to cover a portion of a back side of the decorative material. In one embodiment, the aperture and the deepest portion have circular cross-sections and the diameter of the aperture is smaller than the diameter of the deepest portion, which results in a “mushroom-shaped” stake.

In the hybrid panel produced in the mold, the thermoplastic resin border may comprise at least one molded thermoplastic stake extending from a back side of the thermoplastic resin through an aperture in the outer thinner portion of the decorative material to help bond the decorative material to the thermoplastic resin at an interface between the back side of the thermoplastic resin border and the front side of the outer thinner portion of the decorative material. The stake may comprise a rim extending outwardly from a stake body at a distal end of the stake, the rim configured to engage the back side of the decorative material to hold the decorative material between the back side of the thermoplastic resin border and the rim.

The mold may be provided with a sufficient number of stake-forming features that a plurality of molded stakes are situated around a perimeter of the injection molded hybrid panel.

The plurality of molded stakes may be provided in sufficient number to securely hold the decorative material to the thermoplastic resin border.

The first and second faces may be perpendicular to a line of draw of the panel when the panel is removed from the mold. The first and second faces may not be perpendicular to a line of draw of the panel when the panel is removed from the mold. In the latter, the stake-forming features and stand-offs may have draft angles that follow the line of draw of the finished molded panel for ease of ejecting the panel from the mold.

In one embodiment, a front surface of the thermoplastic resin border and a front surface of the inner decorative portion of the decorative material are essentially flush with each other.

The decorative material may be any suitable material that can withstand the temperature of injection molding while maintaining a class A appearance. In the context of vehicle trim, the decorative material preferably comprises a carpet, a fabric or a sheet, especially a carpet. In one embodiment, the decorative material comprises a compression molded polyester carpet. The thermoplastic resin may comprise any resin suitable for injection molding, for example a thermoplastic polyester, a polyolefin (e.g. polyethylene, polypropylene), etc. The thermoplastic resin preferably has a good flow rate when molten to ensure that the cavity areas in the injection mold are properly filled during molding.

The hybrid panel produced in the injection mold advantageously has a distinct separation appearance between the class A front surface of the decorative material and the thermoplastic resin border. The distinct separation appearance arises from the indent in the panel formed by the first stand-off at the intersection between the thermoplastic resin border and the inner decorative portion of the decorative material. Such a distinct separation provides a more visually appealing panel because the thermoplastic resin border covers the edges of the decorative material, and the indent provides a straight sharp delineation between the decorative material in an interior portion the panel and the thermoplastic resin border on an outer portion of the panel. Further, the first and second stand-offs are off-set in the mold, which provides pinch points through which molten thermoplastic resin cannot bleed on to the class A front surface of the panel, further providing a clean look to the panel. In addition, because thermoplastic resin is used only at the perimeter of the panel and is not used to back the entire panel, there is no thermoplastic resin backing behind the visible decorative material of the class A front surface of the panel and the panel is lighter in weight and less costly to produce.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts a cross-section of a first embodiment of a mold for producing a trim panel in accordance with the present invention;

FIG. 1B depicts a cross-section of the mold shown in FIG. 1A with the trim panel therein;

FIG. 2A depicts a cross-section of the mold of FIG. 1A through a stake-forming feature;

FIG. 2B depicts a cross-section of the mold shown in FIG. 2A with the trim panel therein;

FIG. 3A depicts a back perspective view of a section of the trim panel produced in the mold of FIG. 1;

FIG. 3B depicts a front view of the trim panel produced in the mold of FIG. 1 showing a class A surface of the trim panel;

FIG. 4 depicts a cross-section of a second embodiment of a mold with a trim panel therein similar to one depicted in FIG. 1B except that the mold has mold halves with angled faces;

FIG. 5 depicts a cross-section of the mold shown in FIG. 4 through a stake-forming feature; and,

FIG. 6 depicts a back perspective view of a section of the trim panel produced in the mold of FIG. 4.

### DETAILED DESCRIPTION

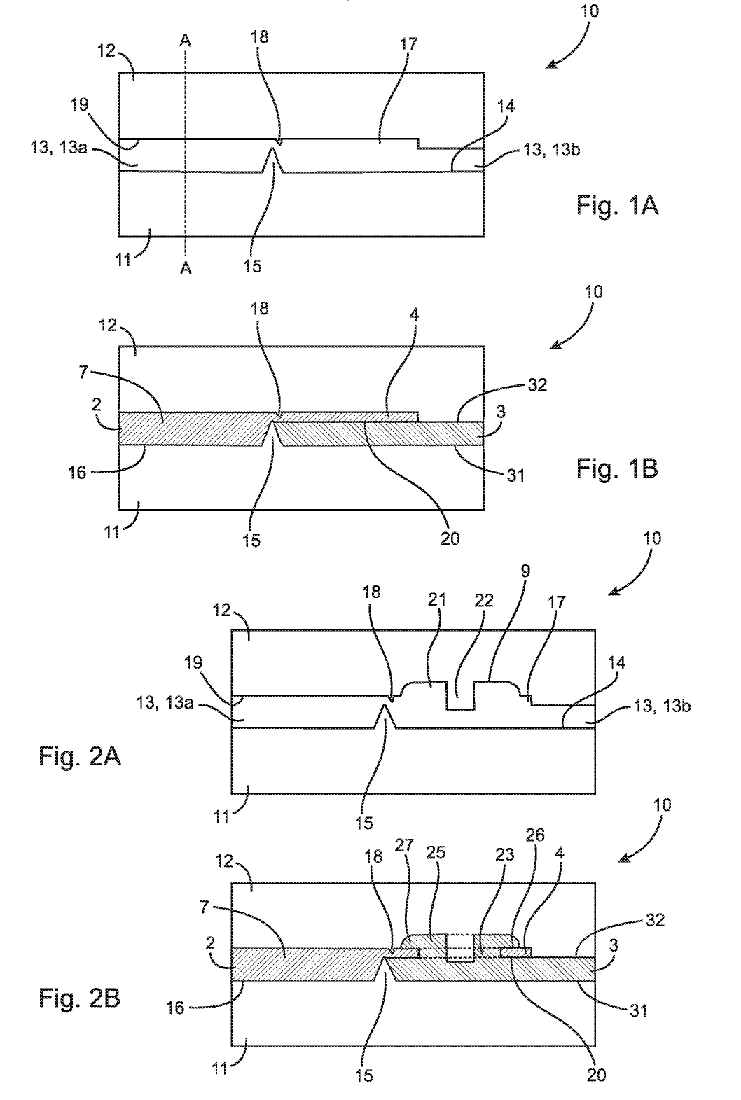

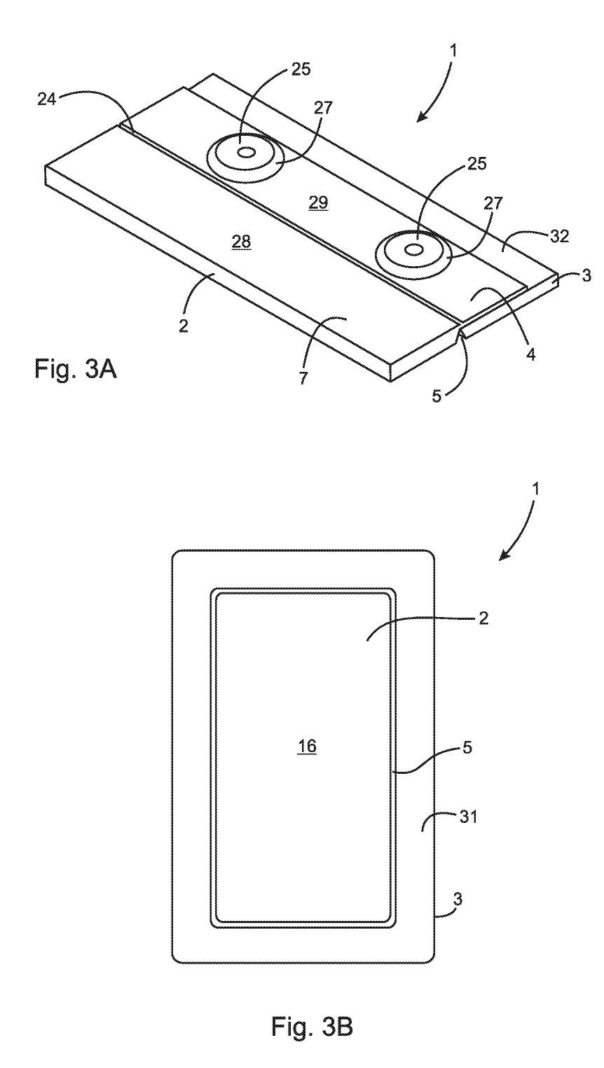

Referring to FIG. 1A, FIG. 1B, FIG. 2A, FIG. 2B, FIG. 3A and FIG. 3B, in producing an embodiment of a trim panel 1 in accordance with the present invention, a compression molded non-woven polyester fiber carpet 2 may be placed into an injection mold 10 and a thermoplastic resin may be injected into the mold 10 to bond edges 4 of the carpet 2 forming a thermoplastic resin border 3 on the edges 4 of the carpet 2, thereby forming the trim panel 1. The injection mold 10 comprises two mold halves, a cavity half 11 mated with core half 12. When the mold 10 is closed, the mold halves 11, 12 form a seal along outer edges of the panel to permit injection of molten thermoplastic resin into the mold 10.

The cavity half 11 comprises a main cavity 13 having a bottom surface 14. The carpet 2 is contained in the main cavity 13 with a class A surface 16 of the carpet 2 oriented towards the bottom surface 14 of the main cavity 13. A large stand-off 15 protrudes from the bottom surface 14 to divide the main cavity 13 into a first main cavity section 13a and a second main cavity section 13b. The large stand-off 15 parallels the entire intersection between the thicker portion 7 of the carpet 2 and the thermoplastic resin border 3. The large stand-off 15 separates the class A front surface 16 of a thicker portion 7 of the carpet 2 contained in the first main cavity section 13a from molten thermoplastic resin during injection molding to help prevent molten thermoplastic resin from bleeding over from the second main cavity section 13b to the class A surface 16 of the thicker portion 7. The large stand-off 15 also helps position the carpet 2 in the mold 10 so that a visible class A front face of the finished molded panel 1 (see FIG. 3B) has a sharp well-defined groove 5 between the visible class A front surface 16 of the thicker portion 7 of the carpet 2 and the thermoplastic resin border 3 at the intersection 6 where the thinner edges 4 of the carpet 2, the thicker interior portion 7 of the carpet 2 and the thermoplastic resin border 3 meet. The groove 5 contributes to a clean, visually appealing appearance of the front of the finished molded panel 1. Covering the class A surface of the thinner edges 4 of the carpet 2 with thermoplastic resin border 3 provides a continuous class A surface appearance when transitioning from the carpeted interior to the thermoplastic resin border 3 of the trim panel 1.

The core half 12 comprises a shallower cavity 17 in which the thinner edges 4 of the carpet 2 are contained when the mold halves 11, 12 are closed. The thinner edges 4 are contained in the shallower cavity 17 directly over second main cavity section 13b so that when molten thermoplastic resin is injected into the second main cavity section 13b of the mold 10, the thermoplastic resin border 3 and the thinner edges 4 of the carpet 2 are mated and overlap to form a bonding interface 20 between a back side 32 of the thermoplastic resin border 3 and a front side of the thinner edges 4. A small stand-off 18 paralleling the entire intersection between the thicker portion 7 of the carpet 2 and the thermoplastic resin border 3 protrudes from an inner surface 19 of the shallower cavity 17. The small stand-off 18 also helps position and helps retain the thinner edges 4 of the carpet 2 at a proper position in the mold 10, and also helps prevent molten thermoplastic resin from bleeding over to the thicker interior portion 7 of the carpet 2. The small stand-off 18 is advantageously off-set laterally outward of the large stand-off 15 when the mold 10 is closed, which is particularly beneficial for preventing resin bleed and properly positioning the carpet 2 in the mold 10. In FIG. 1A, the lateral direction is perpendicular to line A-A, the line A-A extending through the two mold halves 11, 12. A back face of the finished molded panel 1 (see FIG. 3A) also has a sharp well-defined groove 24 between the back surface 28 of the thicker portion 7 of the carpet 2 and a back surface 29 of the thinner edges 4 of the carpet 2.

The large stand-off 15 and small stand-off 18 are immovable with respect to the cavity surfaces from which they extend. The stand-offs 15, 18 are preferably machined features of the mold formed in the mold itself, but they may be formed by addition of material to the mold surfaces. stand-offs 15, 18 cooperate to block passage of molten thermoplastic material from the second main cavity section 13b into the first main cavity section 13a thereby preserving the clean appearance of the thicker portion 7 of the carpet 2 to the inside of the thermoplastic resin border 3 formed on the edges 4 of the carpet 2. The stand-offs 15, 18 also cooperate to correctly position the carpet 2 in the mold and to hold the carpet 2 in place during molding. The large stand-off 15 preferably extends across 75% or more, more preferably 80-90% of the height of the main cavity 13. The small stand-off 18 preferably extends across 10% or less, more preferably 5-10% of the height of the main cavity 13. The stand-offs 15, 18 are laterally off-set from each other with the small stand-off 18 more to the outside of the mold. The off-set advantageously prevents creating a breakable weak point in the carpet 2, which might occur if the stand-offs 15, 18 were too close to being aligned. In addition, the off-set contributes to more accurate positioning and retention of the carpet 2 in the mold 10, and provides a more efficient barrier to molten thermoplastic resin seeking to pass over to the first main cavity section 13a.

Molten thermoplastic resin may be injected into the mold cavities through a sprue, channels and gates (not shown). The gate or gates into the cavities may be located at any convenient location, although the gates are preferably not located on the bottom surface 14 of the main cavity 13 because the class A front surface of the trim panel 1 is formed on the bottom surface 14 of the main cavity 13 of the mold 10.

While FIG. 1A and FIG. 1B depict cross-sections between injection molded stake features, FIG. 2A and FIG. 2B show cross-sections through the stake features. With specific reference to FIG. 2A, FIG. 2B and FIG. 3A, a plurality of mushroom-shaped injection molded thermoplastic stakes 25 (only two shown in FIG. 3A) may be formed through the edges 4 of the carpet 2 to help lock the carpet 2 to the thermoplastic resin border 3. The stakes 25 are integrally molded with the thermoplastic border 3 at a plurality of locations around a perimeter of the trim panel 1 to help secure the carpet 2 to the thermoplastic resin border 3. To form the stakes 25, the shallower cavity 17 in the core half 12 is provided with stake-forming features 9 comprising a plurality of deeper sections 21 in which a substantially cylindrical pillar 22 formed on an inner surface of a deepest section of each deeper section 21 extends. The deeper section 21 has a smaller cross-sectional area than a cross-sectional area of the entire cavity 17 in a plane parallel to a face plane of the core half 12. The pillar 22 extends through a substantially circular aperture 23 in the thinner edge 4 of the carpet 2 when the carpet 2 is in the closed mold 10. The material of the thinner edge 4 surrounds the aperture 23 and the aperture 23 has a somewhat greater diameter than the pillar 22 so that molten resin injected into the second main cavity section 13b may flow between the pillar 22 and an edge of the aperture 23. The deeper section 21 has a diameter somewhat larger than the diameter of the aperture 23 so that molten thermoplastic resin flowing into the deeper portion 21 is able to flow around the edge of the aperture 23 to contact a back surface 26 of the edges 4 of the carpet 2. In this way, a rim 27 is formed at a distal end of the stake 25, which holds the thinner edges 4 of the carpet 2 between integrally molded portions of the thermoplastic resin border 3 providing greater securement of the carpet 2 in the thermoplastic resin border 3.

With specific reference to FIG. 1B, FIG. 2B, FIG. 3A and FIG. 3B, the class A front surface 16 of the carpet 2 and a front surface 31 of the thermoplastic resin border 3 may be formed in the mold 10 so that the surfaces 16, 31 are essentially flush, contributing to a clean, pleasing appearance for the trim panel 1. However, by altering the depth of one or both of the first and second main cavity sections 13a, 13b, a different appearance may be obtained in which the class A front surface of the carpet and the front surface of the thermoplastic resin border may not be flush, but are instead at different relative heights. The class A front surface of the carpet may therefore be recessed or raised relative to the front surface of the thermoplastic resin border.

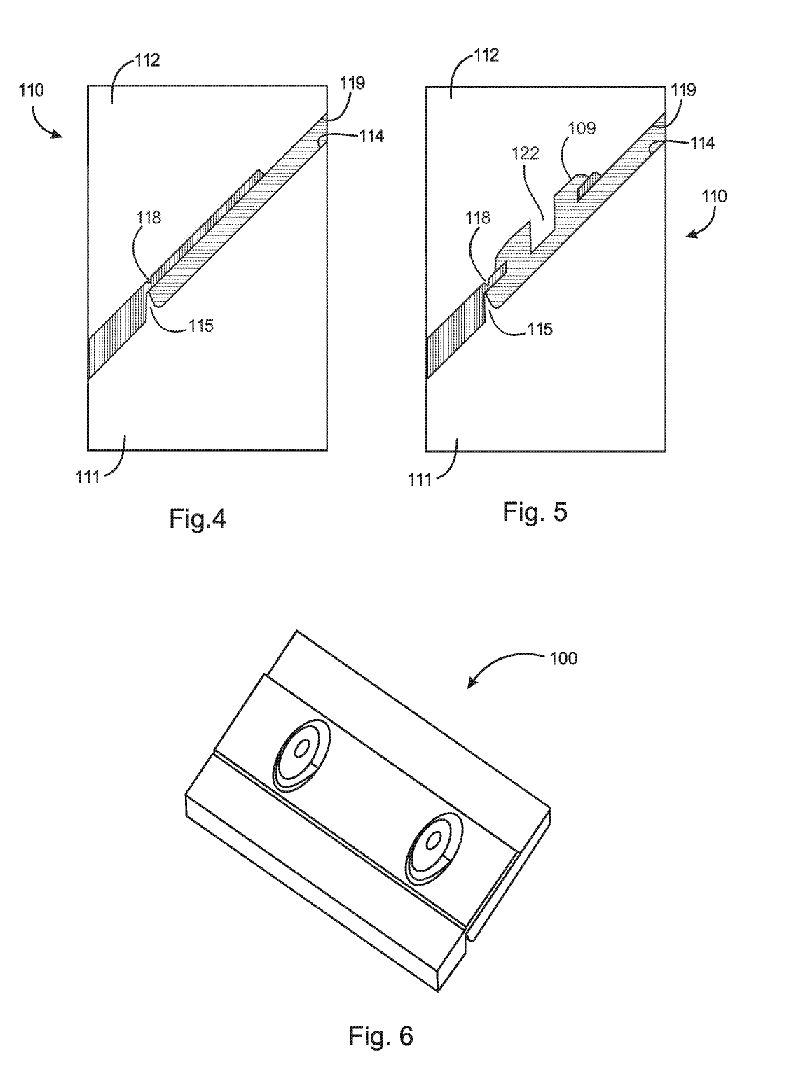

With reference to FIG. 4, FIG. 5 and FIG. 6, a second embodiment of a mold 110 and a trim panel 100 produced therein is similar to the one depicted in FIG. 1 to FIG. 3, except that the mold 110 has mold halves 111, 112 with angled faces 114, 119, with respect to the direction in which the mold halves 111, 112 are separated after molding. For this reason, larger and smaller stand-offs 115, 118, respectively, protrude from their respective cavity surfaces in a direction that follows the line of draw of the mold halves 111, 112. In addition, stake-forming features 109 including pillars 122 therein are angled parallel to the line of draw of the mold halves 111, 112. Angling the stand-offs 115, 118 and stake-forming features 109 to parallel the line of draw facilitates ejecting the finished trim panel 100 from the mold 110. The finished trim panel 100 has a slightly more angular appearance the trim panel 1 described above.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. An injection mold for producing a hybrid panel having a decorative material bordered by a thermoplastic resin, the injection mold comprising:
a first mold part comprising
a first face having a perimeter defining a laterally outward-most edge of the first face,
a first cavity in the first face having a first inner surface,
a first stand-off having a first height extending from and immovable with respect to the first inner surface, the first cavity divided into an inner mold section and an outer mold section by the first stand-off,
the inner mold section configured to contain a first portion of the decorative material that remains uncovered by the thermoplastic resin,
the outer mold section configured to contain a second portion of the decorative material that is to be covered on one side by the thermoplastic resin when the thermoplastic resin is injected into the outer mold section to thereby form an interface between the decorative material and the thermoplastic resin; and,
a second mold part comprising
a second face having a perimeter defining a laterally outward-most edge of the second face, the second face configured to mate with the first face to close the mold,
a core in the second face comprising a second cavity shallower than the first cavity and having a second inner surface,
the second cavity configured to contain the second portion of the decorative material over the outer mold section of the first cavity,
a second stand-off having a second height extending from and immovable with respect to the second inner surface, the second height smaller than the first height, the second stand-off off-set laterally outwardly from the first stand-off and projecting into the outer mold section when the mold is closed.

2. The mold according to claim 1, wherein the second cavity has smaller perimetrical dimensions than the first cavity, the first and second faces forming a seal when the mold is closed to prevent injected thermoplastic resin from flowing around and/or over an outer perimetrical edge of the second portion of the decorative material.

3. The mold according to claim 1, wherein the first and second mold parts are configured to compress the second portion of the decorative material.

4. The mold according to claim 1, wherein the second mold part further comprises at least one stake-forming feature, the stake-forming feature situated over the outer mold section of the first cavity laterally inwardly of a perimeter of the second cavity when the mold is closed and configured to receive thermoplastic resin to form a molded thermoplastic stake through the second portion of the decorative material to help bond the decorative material to the thermoplastic resin at the interface between the injected thermoplastic resin and a front side of the second portion of the decorative material.

5. The mold according to claim 4, wherein the stake-forming feature comprises a deeper portion of the second cavity, the deeper portion having a smaller cross-sectional area than a cross-sectional area of the second cavity in a plane parallel to a plane of the second face, the deeper portion having a deepest portion, the deeper portion having a protrusion extending therein from the second inner surface, the deeper portion situated over a flow-through aperture in the second portion of the decorative material so that the protrusion extends into the aperture leaving a gap between the protrusion and an inner edge of the aperture for molten thermoplastic resin injected into the mold to flow through the gap, the aperture having a smaller cross-sectional area than a cross-sectional area of the deepest portion of the deeper portion to permit molten thermoplastic resin flowing through the decorative material to cover a portion of a back side of the decorative material.

6. The mold according to claim 1, wherein the first and second faces are perpendicular to a line of draw of the panel when the panel is removed from the mold.

7. The mold according to claim 1, wherein the first and second faces are not perpendicular to a line of draw of the panel when the panel is removed from the mold.

8. A hybrid panel comprising a decorative material having a class A front surface and a class B back surface, the decorative material bordered by a border of a thermoplastic resin, the decorative material comprising an inner decorative portion not covered by thermoplastic resin on the class A front surface and an outer thinner portion covered on the front surface by the thermoplastic resin, the front surface of the decorative inner portion separated from the thermoplastic resin by an indent along an intersection between the decorative material and the thermoplastic resin.

9. The panel according to claim 8, wherein an outer perimetrical edge face of the decorative material is not covered by the thermoplastic resin border.

10. The panel according to claim 8, wherein the inner decorative portion of the decorative material is not covered by thermoplastic resin on the class B back surface.

11. The panel according to claim 8, wherein the thermoplastic resin border comprises at least one molded thermoplastic stake extending from a back side of the thermoplastic resin through an aperture in the outer thinner portion of the decorative material to help bond the decorative material to the thermoplastic resin at an interface between the back side of the thermoplastic resin and the front side of the outer thinner portion of the decorative material.

12. The panel according to claim 11, wherein the stake comprises a rim extending outwardly from a stake body at a distal end of the stake, the rim configured to engage the back side of the decorative material to hold the decorative material between the back side of the thermoplastic resin border and the rim.

13. The panel according claim 11, wherein the at least one molded thermoplastic stake comprises a plurality of molded stakes situated around the panel.

14. The panel according to claim 8, wherein a front surface of the thermoplastic resin border and the front surface of the inner decorative portion of the decorative material are essentially flush with each other.

15. The panel according to claim 8, wherein the decorative material is a carpet.

16. The panel according to claim 8, wherein the decorative material is a compression molded polyester carpet.

17. The panel according to claim 8, wherein the thermoplastic resin comprises a thermoplastic polyester.

18. A process for producing a hybrid panel having a decorative material bordered by a thermoplastic resin, the process comprising:
placing a decorative material in an injection mold as defined in claim 1;
injecting molten thermoplastic resin into the outer mold section of the first mold part;
allowing the thermoplastic resin to cool and solidify; and,
separating the first and second mold parts and removing the hybrid panel formed therein from the mold.

19. The process according to claim 18, wherein the second portion of the decorative material is compressed between the first and second mold parts when the mold is closed.

20. The process according to claim 18, wherein the first and second stand-offs deform the decorative material when the mold is closed to prevent movement of the decorative material in the mold during injection of the molten thermoplastic resin, and the off-set of the first and second stand-offs provides pinch points that prevent molten thermoplastic resin injected into the outer mold section of the first mold part from bleeding over from the outer mold section into the inner mold section of the first mold part to prevent covering a front surface of the first portion of the decorative material with the thermoplastic resin, the first stand-off providing an indent in a front surface of the produced hybrid panel along an intersection between the front surface of the first portion of the decorative material and the thermoplastic resin thereby separating the front surface of the first portion of the decorative material from the thermoplastic resin border.
